(19) United States
(12) Patent Application Publication
(10) Pub. No.: US 2008/0250075 A1
(43) Pub. Date: Oct. 9, 2008

(54) DOCUMENT MANAGEMENT SYSTEM AND ITS CONTROL METHOD

(75) Inventor: Satoshi Imai, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/970,093

(22) Filed: Jan. 7, 2008

(30) Foreign Application Priority Data
Apr. 6, 2007 (JP) 2007-100272

(51) Int. Cl. G06F 12/00; G06F 17/30

(52) U.S. Cl. 707/200; 707/E17.134

(57) ABSTRACT

This invention provides a document management system regarding deleted information for suppressing restoration of information that one does not wish to be referred to again. This invention comprises an electronic document DB device in which a DB is stored and a DB device used for electronic document backup that stores a BDB. When the electronic document to be deleted of the DB stored in the electronic document DB device is indicated, the DMA deletes the electronic document from the DB. Furthermore, when the electronic document is indicated, the DMA deletes the electronic document corresponding to the electronic document in the BDB stored in the DB device used for backup from the DB device used for electronic document backup.

### BACKGROUND OF THE INVENTION

1. Field of the Invention

This invention relates to a document management system and its control method. More specifically, it relates to an electronic document management system (document management application: DMA) operating on a PC that controls electronic documents created by various applications through a database (DB) and stores them in the DB device.

2. Description of the Related Art

In this specification “the database (DB)” refers to the aggregate of data (e.g., electronic documents, management tables, etc.). This DB is used, for example, when retrieving. Furthermore, there may, of course, be instances in which only one piece of data is set up in the DB but even in these instances the DB refers to this one piece of data.

Additionally, in this specification “the database (DB) device” is a storage device for saving the DB.

The technology for creating these DB has existed in various forms for a long time and the technology for backing up a DB to form a BDB is also well known. Furthermore, henceforth, the aggregate of data created and backing up a DB will be called the backup database (BDB).

Incidentally, various types of confidential electronic documents are included in the DB in this DB device. Consequently, depending on necessity in connection with the Private Information Protection Law the confidential electronic document in the DB must be manually deleted from the DB in the DB device.

Furthermore, in order to completely remove the confidential electronic document, it must also be removed manually from the BDB and it is necessary to carry out the three troublesome operations given below by hand with respect to the entire BDB that includes the confidential electronic document.

(1) Restoring the BDB (transferring the BDB stored in the DB device used for backup to the DB device in use) is carried out manually. Furthermore, the transferred BDB is handled as a DB in the DB device during use.

(2) The confidential electronic document included in the DB in the DB device being used is deleted manually.

(3) The DB in the DB device is backed up manually and the BDB is created in the DB device used for back up.

A further detailed explanation is given using FIG. 2 to explain the operations of (1), (2) and (3).

First, an explanation is given regarding the perspective of FIG. 2.

The DMA202 runs on the PC201 and the DB shall be stored in the DB device 203. Additionally, the DMA running on the PC201 creates the backup databases (BDB) 204 and 205 in a plurality of DB devices used for backups. Further, the BDB is also stored in a removable medium such as a CD by the read/storage device of the portable storage medium.

In this type of situation, in order to completely remove the confidential electronic document in the BDB in the DB device used for backup,

[1] first, the BEB204 is restored. By doing this, the BDB in the DB device used for backup is transferred to the DB in the DB device 203. Additionally, the BDB transferred is treated as a DB in the DB device in use.

[2] Subsequently, the confidential electronic document included in this DB is deleted manually in the DB of the DB device 203 in use.

[3] Then, the DB which does not include the confidential electronic document is transferred to the DB device used for backup and the BDB204 is recreated.

It is also necessary to carry out the same processing of these operations with respect to the BDB present in the BDB205 or DC206.

However, this requires a great deal of time and effort.

Managing the electronic document without damaging its originality in the electronic storage is indicated in Japanese Patent Laid-open No. 2002-82821 even when backup is carried out. However, the technology for suppressing the referring to prescribed information again from the BDB is not disclosed.

### SUMMARY OF THE INVENTION

The objective of this invention is to provide a document management system and its control method with which it will be possible to not have information restored that one does not wish to be referred to a second time.

In first aspect of the present invention, a document management system comprises a storage device that stores a electronic document group; a backup storage device that obtains the electronic document group stored in the storage device to store; and a deletion means for deleting an electronic document from the electronic document group in the storage device when the electronic document to be deleted of the electronic document group stored in the storage device is indicated; wherein the document management system comprises a control means that deletes the indicated electronic document from the storage device, and controls so that an electronic document corresponding to the indicated electronic document of the electronic document group stored in the backup storage device is not transferred to the storage device, when the electronic document to be deleted from the electronic document group stored in the storage device is indicated.

In second aspect of the present invention, a control method of a document management system comprises a storage device that stores a electronic document group; a backup storage device that obtains the electronic document group stored in the storage device to store; and a deletion means for deleting an electronic document from the electronic document group in the storage device when the electronic document to be deleted of the electronic document group stored in the storage device is indicated; wherein the control method has a control step that deletes the indicated electronic document from the storage device, and controls so that an electronic document corresponding to the indicated electronic document of the electronic document group stored in the backup storage device is not transferred to the storage device, when the electronic document to be deleted from the electronic document group stored in the storage device is indicated.

According to this invention, the restoration of information from information that has already been deleted that one does not wish to be referred to again is restrained.

Further features of the present invention will become apparent from the following description of exemplary embodiments (with reference to the attached drawings).

### BRIEF DESCRIPTION OF THE DRAWINGS

FIG. 1 is a diagram explaining the structure of the hardware for implementing the programs relating to one embodiment of this invention;

FIG. 2 is a diagram explaining conventional processing for completely deleting confidential information data;

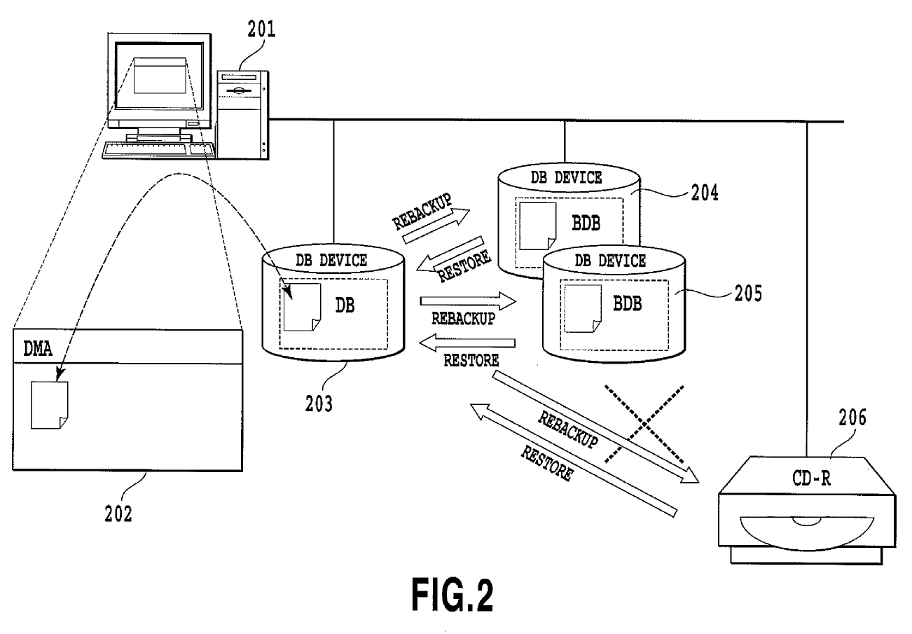

FIG. 3 is a diagram explaining the operating screen of the document management application and the database relating to one embodiment of this invention;

FIG. 4 is a diagram explaining the deletion history management table relating to one embodiment of this invention;

FIG. 5 is a diagram explaining the registering in the deletion history management table at deletion time for the electronic documents and the backup of the DB relating to one embodiment of this invention;

FIG. 6 is a diagram explaining verification using the deletion history management table for each electronic document at DB restoration time relating to one embodiment of this invention;

FIG. 7 is a diagram showing the flow chart that explains the processing making possible the setup of the information protection flag only in the encoded DB relating to one embodiment of this invention;

FIG. 8 is a diagram showing the flow chart explaining the registering of the electronic document in the deletion history management table at the time of deletion and the DB backup processing relating to one embodiment of this invention;

FIG. 9 is a diagram showing the flow chart explaining the processing of the setup of the information protection flag in FIG. 3;

FIG. 10 is a diagram showing the flow chart explaining the restore processing of the back up DB (BDB) in FIG. 6;

FIG. 11 is a diagram explaining the operating screen of the document management application and the database relating to one embodiment of this invention;

FIG. 12 is a diagram explaining the deletion of the registering of the electronic document in the deletion history management table at deletion time and the deletion of the backup data relating to one embodiment of this invention; and

FIG. 13 is a diagram explaining the flow chart that explains the deletion processing from the BDB of the electronic document by means of the operator in FIG. 12 relating to one embodiment of this invention.

### DESCRIPTION OF THE EMBODIMENTS

A detailed explanation is given below of the embodiments of this invention referencing the diagrams.

Furthermore, in the diagrams explained below, those parts having the same function have the same symbols so that repeated explanations are omitted.

As the first embodiment, when the electronic document (for which the information protection flag is ON) included in the DB in the DB device is deleted by the user, the control operation is disclosed so that this electronic document cannot be returned from the BDB in the DB device used for backup.

According to this, when important electronic documents that are contained in the DB in the DB device are deleted, it is possible to make sure that the use of these important electronic documents is prevented.

### First Embodiment

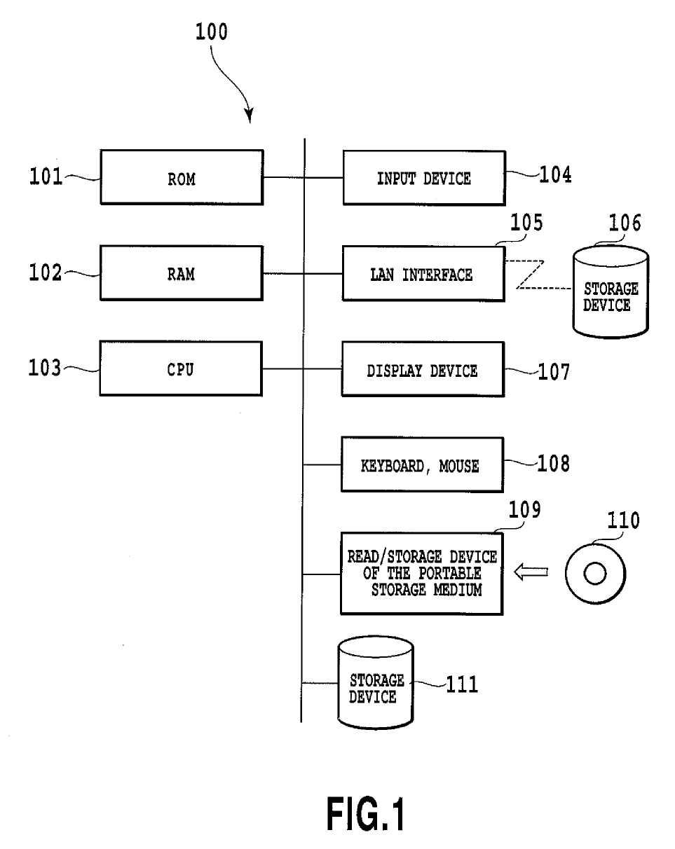

FIG. 1 is a diagram explaining the structure of the hardware of the computer (PC) 100 actualizing this embodiment. 101 is the ROM storing the control program (computer program) for the DMA and the processing to be described later and normally nonvolatile memory is used. 102 is the RAM in which it is possible to temporarily store the data or input data for the processing operations of the CPU and normally volatile memory is used. 103 is the CPU which carries out the processing operations such as various types of calculations, control and discriminations.

104 is the device for inputting data from the outside and the input/output device FDD and the USB equipment are assigned to this. 105 is the LAN interface and by networking it is possible to connect the computer to a general memory device such as the outside storage device 106 of the HDD and a Web or mail server. 107 is the display device used for display, 108 is the inputting operations part that inputs predetermined commands or data and the keyboard and mouse are assigned to it. 109 is a device for carrying out write/read on the portable media 110 such as a CD or outside attached hard disk and it can be connected as with the LAN interface 105 through networking. 111 is the main memory device used normally with a hard disk drive and can also be connected through networking like the LAN interface 105.

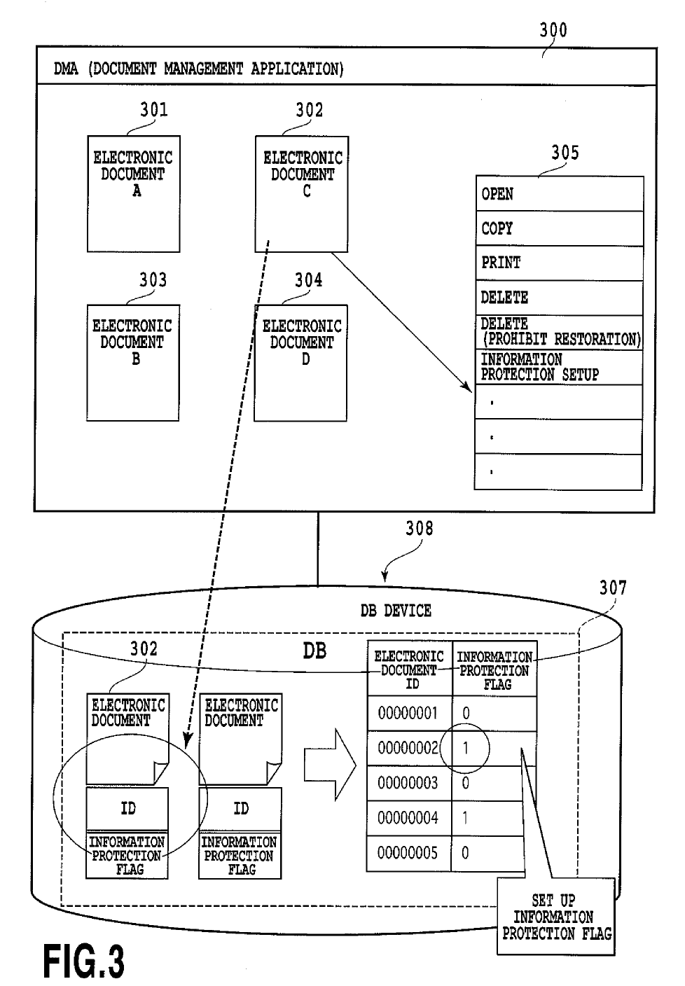

The document management application (DMA) 300 as shown in the upper half of FIG. 3 running on the PC100 displays the DB in the DB device 308 controlled by the DMA 300 on the display screen of the PC 100. The electronic documents A301, B302, C303 and D304 are included in this DB.

Additionally, the DB device 308 also stores the ID (identifying information) and information protection flag for each electronic document.

When the operator of the PC100 right clicks with the mouse on the electronic document C302 in this environment, the pulldown menu 305 is displayed on the display device 107 used for display. From the pulldown menu 305, ‘open’, ‘copy’, ‘print’, ‘delete’, ‘delete (prohibit restoration)’ and ‘information protection setup’ can be selected by the user.

### <Information Protection Setup> and <Information Protection Flag>

When the command ‘information protection setup’ is executed by the user for a certain electronic document, the DMA300 sets the information protection flag of the electronic document to “1” (ON) in the management table in the DB307. Furthermore, the information protection flags of each electronic document are set to the default “0” (OFF).

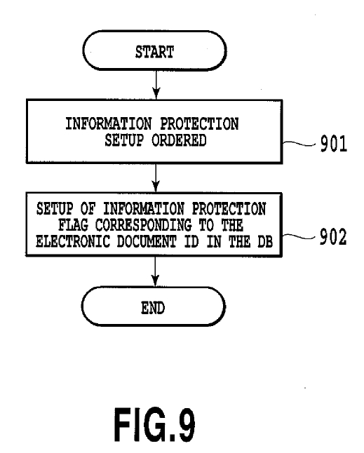

FIG. 9 shows the flow chart explaining in detail the processing to set this information protection flag to ON.

In S901, when right clicking with the mouse cursor keyed on an electronic document and selecting ‘information protection setup’ from the pulldown menu, the DMA300 receives the information protection setup command for the electronic document.

In S902, the DMA300 changes the information protection flag of the electronic document ID (electronic document ID of the management table in the DB307) corresponding to the electronic document for which the information protection setup command has been issued from “0” to “1”.

### <Management Table>

In this embodiment, the ‘management table’ is the data for linking the ‘electronic document ID’ for each electronic document in the DB and ‘information indicating whether or not to prohibit its electronic document restoration=the information protection’ to manage.

In this embodiment, as described subsequently, when the user issues the ‘delete’ command for an electronic document (normal electronic document) whose information protection flag in the management table of the DB307 is set at ‘0’, the electronic document as per usual is deleted by the DMA300. However, there is no control in the DMA300 to prevent this electronic document from returning to the DB device 308 from the DB device used for backup.

On the other hand, when the ‘delete’ command is issued for an electronic document whose information protection flag is set at “1”, not only is this electronic document deleted from the DB device 308 but the following also occurs. That is, the DMA300 in addition to the above deletion also controls the electronic document so that it cannot return to the DB device 308 from the DB device used for backup.

### <Deletion History Management Table>

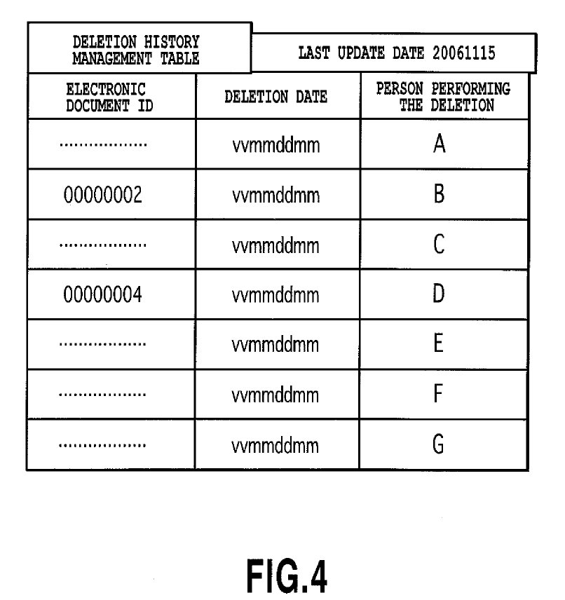

FIG. 4 is used to explain the specific structure in order to implement this control and an explanation will be given regarding the deletion history management table.

The ‘deletion history management table’ is a table for controlling the ID (identifying information) of an electronic document whose information protection flag is set to “1”.

Specifically, the deletion history management table includes information about the ‘electronic document ID’, ‘date of deletion’ and the ‘person performing the deletion’ for the electronic document whose information protection flag is set to “1”.

The ‘electronic document ID’ is the unique number given to the electronic document in the DMA, the ‘deletion date’ is the day the electronic document is deleted and the ‘person performing the deletion’ is the login ID of the operator commanding the deletion.

<Processing Flow when Deletion of an Electronic Document is Commanded by a User>

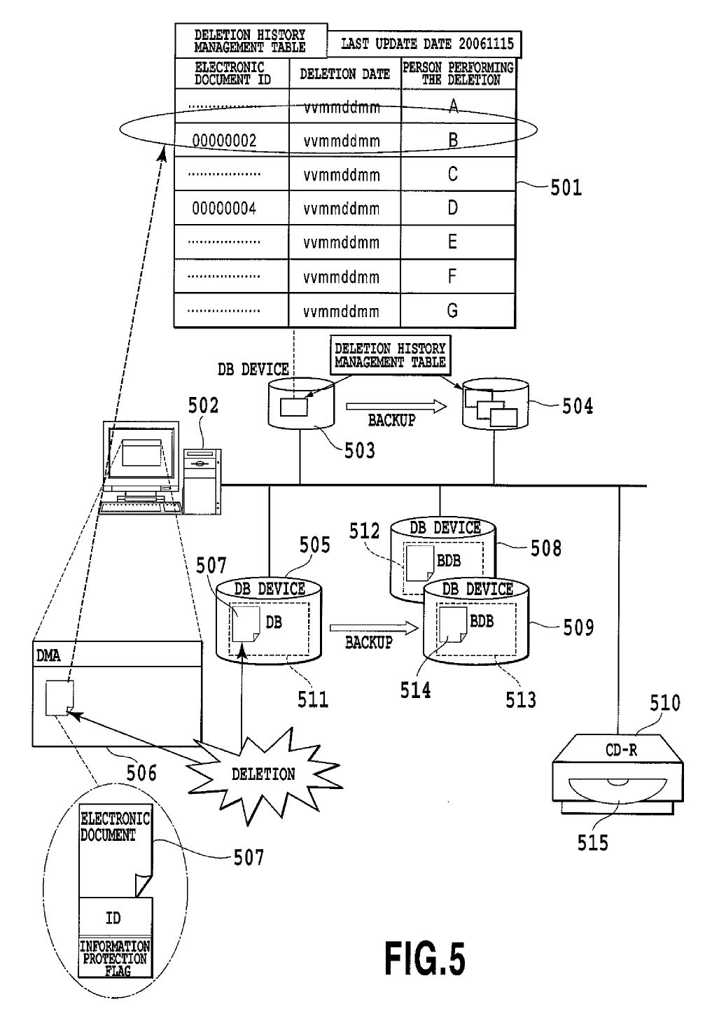

With the same DMA as in FIG. 3, FIG. 5 is a diagram explaining the processing flow when deletion of an electronic document is commanded by a user. The DMA 506 shown in FIG. 5 is the same as the DMA 300 shown in FIG. 3. Furthermore, the DB device 505 shown in FIG. 5 is the same as the DB device 308 shown in FIG. 3.

In FIG. 5 the electronic document DB device 505 is the storage device storing the DB as the electronic document group (the aggregate of electronic documents) and stores the DB511 which includes the electronic document 507. The DB device 509 used for electronic document backup is the backup storage device that stores the BDB513 containing the electronic document 514 which is the backup data of the electronic document 507. The DB device 509 used for electronic document backup obtains the DB511 stored in the electronic document DB device 505 as a backup and stores it as the BDB513. The DB device 508 used for electronic document backup stores the BDB512 which is a backup of the DB that is different from the DB511 stored in the electronic document DB device 505. The deletion history management table DB device 503 stores the deletion history management table 501. The DB device 504 used for deletion history management table backup receives the deletion history management table 501 stored in the deletion history management table DB device 503 as a backup and stores it as the backup deletion history management table.

When ‘delete’ of the electronic document is commanded by the operator, the DMA 506 receiving this deletion command verifies whether or not the information protection flag “1” in the electronic document 507 in the DB511 is set. If the information protection flag is set at “1”, the DMA506 deletes the electronic document 507 from the electronic document DB device 511 and registers the electronic document ID, deletion date and person performing the deletion in the deletion history management table 501. That is, the electronic document to be deleted is deleted from the DB in the storage device.

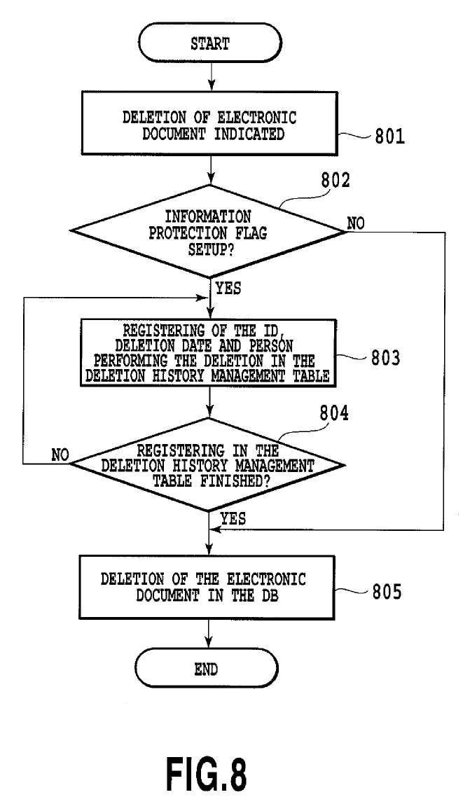

The specific processing flow of <Processing flow when deletion of an electronic document is commanded by a user> is explained using the flow chart of FIG. 8.

In S801, when there is a ‘delete’ command for the electronic document from the operator, the DMA506 receives this command (command for the electronic document to be deleted in the DB511).

In S802, the DMA506 refers to the management table in the DB511 and determines whether or not the information protection flag of the requested electronic document is set to ON. If so, the DMA506 proceeds to S803. If not, the DMA506 proceeds to S805.

In S803, the DMA 506 registers the electronic document ID, the deletion date and person performing the deletion of the electronic document commanded to be deleted in the deletion history management table 501.

Next, the DMA506 determines whether the registering in the deletion history management table 501 is complete or not (S804) and if it is not registered, the processing of S803 is carried out again. If it can be registered, the DMA506 proceeds to S805. In S805, the DMA506 carries out the deletion of the electronic document in the DB511 in the electronic DB device 505 and processing is completed.

In this embodiment, the deletion history management table 501 may also be stored in the same DB device as that in which the electronic document is stored. As described above, when the DB and the DB device are damaged, it is possible to restore the deletion history management table 501 through control by the deletion history management table DB device 503 which is a DB device that is different from the DB device storing the electronic document. To prepare for such DB or DB device damage, it is preferable to back up many versions more frequently than that in the electronic document DB device 505 so that the latest possible data can be restored. This deletion history management table 501 is possible to be encoded, making it possible to prevent the electronic document from being removed through a malicious operation.

It is also possible for the DB511 which is the aggregate body of the electronic documents to be stored separately from this in the DB device and with the objective of long term storage of a plurality of DB versions of damaged PCs or DBs, PC system replacements or with specific dates it is possible to create it as a BDB in the DB device. Furthermore, it is possible to store the BDB using the portable storage medium read/storage device 510.

<Processing Flow when Electronic Document Restoration is Commanded>

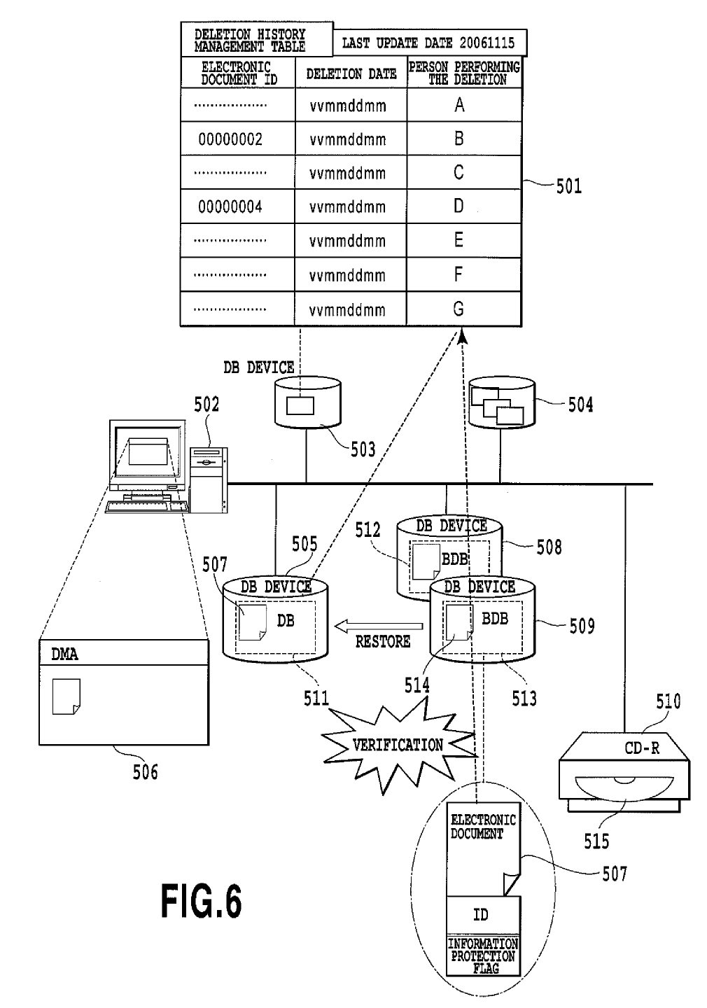

FIG. 6 is a diagram explaining the processing flow when restoring from the BDB512, 513 or CD515 backed up in the DB devices 508 and 509 used for electronic document backup in the DMA506 running on the PC502.

When restore is commanded by the administrator, the DMA506 is connected to the DB device 508, 509 used for electronic document backup or the portable storage medium read/storage device 510 in which CD515 is inserted. Next, the DMA506 collects the electronic document ID of the restore targeted electronic document and verifies it with the electronic document ID of the deletion history management table 501.

As a result of the verification, only the restore processing of a non-matching electronic document is controlled so as to continue. That is, only the non-matching electronic document is moved to the DB device 505 from the DB device 508, 509 used for electronic document backup or the portable storage medium read/storage device 510 in which CD515 is inserted.

Conversely, when the electronic document ID of the deletion history management table and the restore targeted electronic document ID are in agreement, the DMA506 exerts control so that restore processing does not take place. In this manner, in this embodiment control is exerted so that the electronic document controlled by restore prohibition in the BDB stored in the backup storage device is never moved to the storage device.

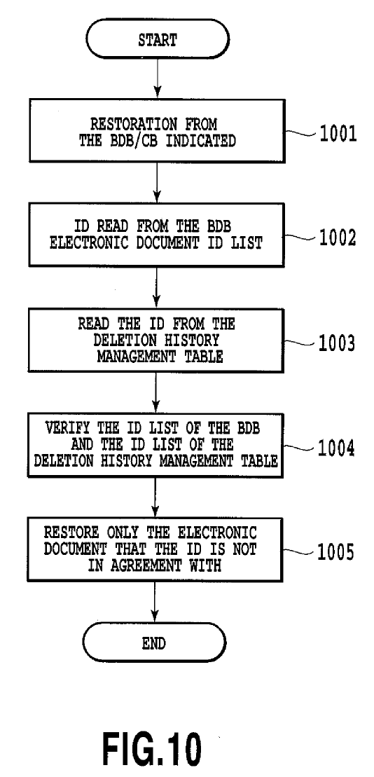

An explanation will now be given in detail using FIG. 10 regarding this processing.

In S1001, when restore from the BDB or the CD is commanded by the administrator, the DMA506 receives the command for the restore. In S1002 the electronic document ID list is taken out from the BDB512, 513 in the DB device 508 or 509 used for electronic document backup or the BDB in the CD515.

In step S1003 the DMA506 takes out the electronic document ID registered previously from the deletion history management table 501.

In S1004 the DMA506 verifies the electronic document ID taken out in S1002 and the electronic document ID taken out in S1003. During this verification, by taking out the electronic document ID from the table that has less electronic document IDs and comparing with the table that has more electronic document IDs.

In S1005 the DMA506 completes the restore processing of only the electronic document with a non-matching electronic document ID from the results of the comparison made in S1004.

Furthermore, displaying the electronic document for which the electronic document ID in the deletion history management table and the restore targeted electronic document ID are in agreement by graying out the icon in order to specify restore rejection or if not displaying either may be switched. The administrator or operator can set up this type of switching beforehand.

In this manner, in this embodiment a verification can be made by comparing the electronic document ID of the electronic document in the BDB and the electronic document ID in the deletion history management table at restore time and depending on the verification results a determination is made as to whether or not to allow restore processing. Consequently, it is possible to suppress restoration of an electronic document that one does not wish to refer to again. Furthermore, registering of the electronic document ID in the deletion history management table performs the function of automatically removing the electronic document that is not desired to refer again from the object of the restoration. Because this registering can be carried out when requested by the operator or administrator, it is possible at their discretion to select the time when they wish to refer again time and when not.

<The Processing Flow when ‘Delete (Prohibit Restoration)’ of the Electronic Document is Commanded by the Operator>

When ‘delete (prohibit restoration) of the electronic document is commanded by the operator, the DMA506 receiving this deletion command in addition to setting the information protection flag in the electronic document 507 to “1”, deletes the electronic document 507 from the electronic document DB device 511. The DMA506 registers the electronic document ID, deletion date and person performing the deletion in the deletion history management table 501. A further explanation will be given concerning this deletion (prohibit restoration).

In order to delete the electronic document C302 as a confidential electronic document, the operator specifies the deletion (prohibit restoration) to the electronic document C302. The DMA300 which has received this assignment sets the information protection flag “1” of the electronic document ID (00000002) of the electronic document in the DB307 in the management table. That is, the DMA300 registers at least the electronic document ID of the electronic document 302 for which deletion is commanded in the deletion history management table. In this manner, by setting the information protection flag to “1”, the electronic document C302 cannot be returned to the DB device 308 from the DB device used for backup. Additionally, the DMA300 executes the deletion of the electronic document C302 in the DB device 308. By means of this deletion (prohibit restoration), ‘information protection setup’ and ‘deletion operation’ can be carried out together.

Furthermore, in this embodiment registering in the deletion history management table is not the registering of the electronic document ID of all electronic documents but is the registering of the electronic document ID of special electronic documents for which setup has been done for prohibiting restoration and then deleted. In this manner, as a result of registering only the electronic document ID of special electronic documents in the deletion history management table, the amount of data in the deletion history management table is kept to a minimum.

Additionally, the ‘deletion (prohibit restoration)’ menu and the ‘information protection setup’ menu are displayed only when the operator logged in on the PC has the authority (when the operator has administrator authority). As a result, when the operator logged in on the PC does not have the authority (when the operator has just rank and file authority), they are not displayed.

Additionally, the ‘delete (prohibit restoration)’ menu and the ‘information protection setup’ menu may be left displayed as far as they are set so that an operator with weak authority cannot use them.

### Second Embodiment

In the first embodiment, when the electronic document (with the information protection flag ON) contained in the DB in the DB device is deleted by the user, a control operation is disclosed so that this electronic document cannot return from the BDB in the DB device used for backup.

According to this, when the important electronic document contained in the DB in the DB device is deleted, it is no longer possible to use this important electronic document.

In contrast, in the second embodiment an operation is disclosed in which this electronic document is also deleted from the BDB in the DB device used for backup when the electronic document (with the information protection flag ON) contained in the DB in the DB device is deleted by the user.

According to this, even in the second embodiment in a manner similar to the first embodiment, when the important electronic document contained in the DB in the DB device is deleted, it is no longer possible to use this important electronic document.

Furthermore, in the method of the second embodiment, as a result of the important electronic document being also deleted from the BDB in the DB device used for backup, the important electronic document is completely deleted with the result that security is higher than for the first embodiment.

On the other hand, because it deletes from the BDB the same electronic document as that deleted from the DB device, the drawback is that it takes an extremely long time to retrieve this electronic document from the BDB. Additionally, there is also the drawback that all of the CDs have to be set one by one in order to delete the electronic document. Furthermore, when the CD is an edit prohibited media like a CD-R, in the second embodiment the drawback is that protection of the important electronic document cannot be achieved. This drawback of the second embodiment is, conversely speaking, an asset of the second embodiment.

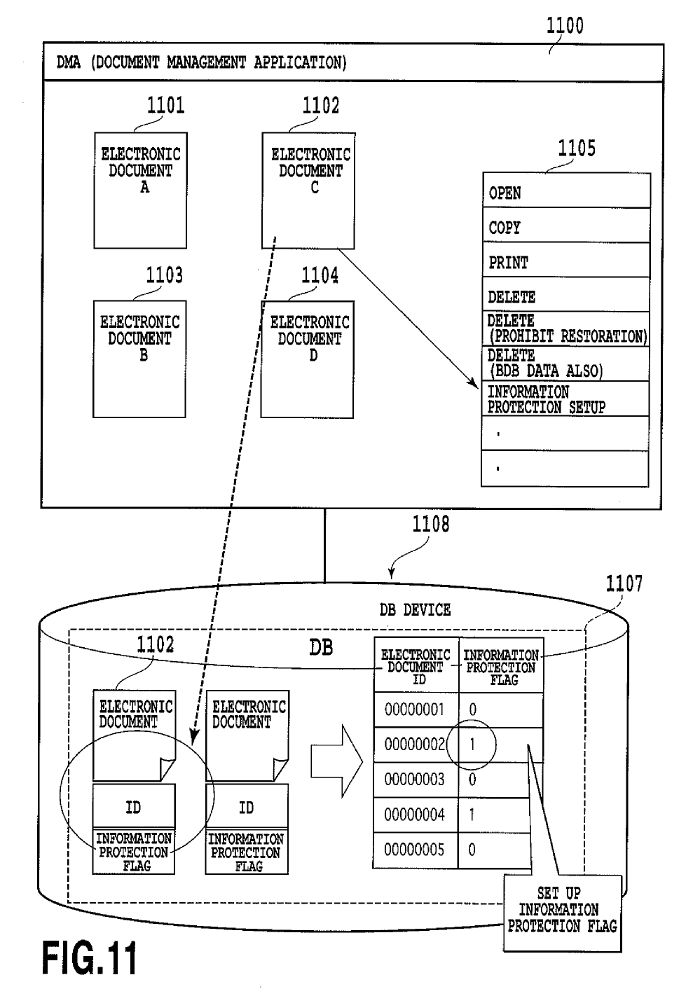

FIG. 11 explains the way the data of the operating screen on the PC 100 of the DMA1100, the electronic document in the DB1107 in the DB device 1108, the ID and the information protection flag is held. It is possible to manage and edit a plurality of electronic documents (electronic document A1101, electronic document B1102, electronic document C1103 and electronic document D1104) in the DMA1100.

When the operator right clicks with the mouse on the electronic document C1102, the pulldown menu 1105 becomes displayed on the display device 107 used for display. It is possible to select ‘open’, ‘copy’, ‘print’, ‘delete’, ‘delete (prohibit restoration)’, ‘delete (delete BDB data also)’ and ‘information protection setup’ and other operations from the pulldown menu 1105.

With the ‘information protection setup’ menu the operator can switch the display/not display and display/grayout depending on the authority when logging in on the PC100. Furthermore, it is possible to carry out the same switching with regard to the ‘deletion (prohibit restoration) and ‘deletion (delete BDB data also)’ with which the ‘information protection setup’ and ‘deletion operation’ can be carried out together.

The operator specifies the ‘delete (delete BDB data also)’ in order to control the electronic document C1102 as a confidential document. By this designation, the DMA1100 sets the information protection flag of the ID:00000002 corresponding to the electronic document 1102 of the DB1107 in the DB device 1108 to “1”.

Subsequently, the electronic document C1102 is treated as a confidential electronic document. When the electronic document C1102 is deleted from the DB1107 in the DB device 1108, the DMA1100 retrieves the BDB in the readable/rewritable DB device used for electronic document backup and if there is an electronic document with the ID: 00000002, it is deleted from the BDB. If there is an electronic document with the ID: 00000002 in the BDB stored in a readable/nonrewritable CD, it is no longer possible to read the electronic document C1120 in the same way as with the first embodiment.

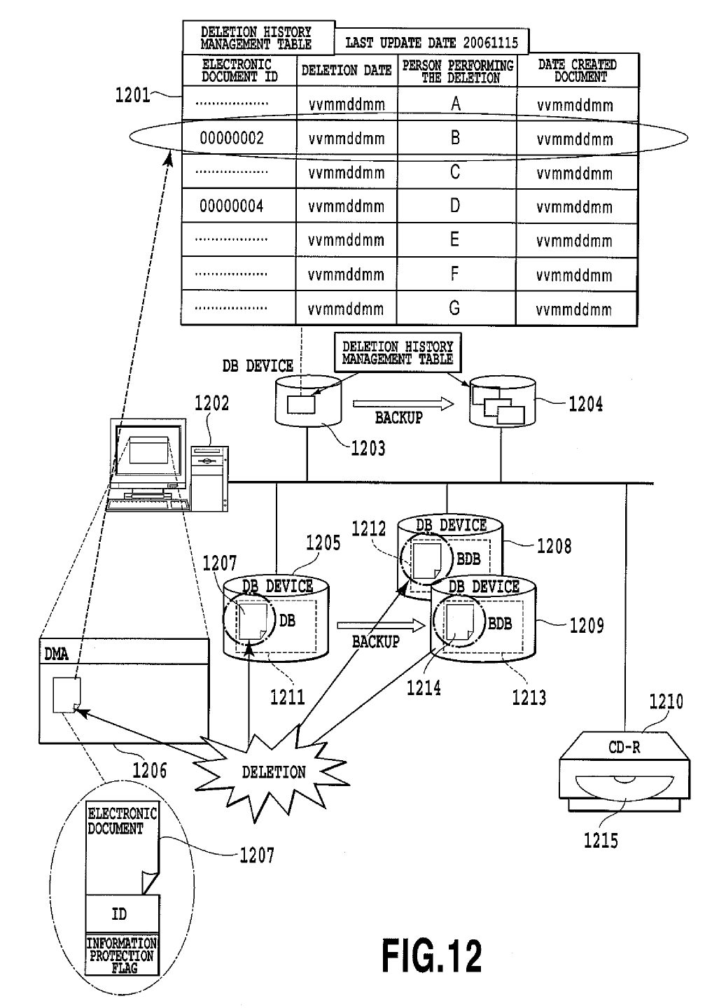

FIG. 12 is a diagram explaining the flow regarding the deletion history management table and backup of the electronic document in the DMA1206 running on the PC1202.

In FIG. 12 the electronic document DB device 1205 stores the DB1211 containing the electronic document 1207. The DB device 1209 used for electronic document backup stores the BDB1213 which contains the electronic document 1214 which is the backup data of the electronic document 1207. The DB device 1208 used for electronic document backup stores the BDB1212 which is the backup for a DB different from the DB1211 stored in the electronic document DB device 1205. The deletion history management table DB device 1203 stores the deletion history management table 1201. The DB device 1204 used for deletion history management table backup obtains the deletion history management table 1201 stored in the deletion history management table DB device 1203 as a backup and stores in as a backup deletion history management table.

When the ‘delete (delete BDB data also)’ of the electronic document is commanded by the operator, the DMA1206 receiving this deletion command verifies whether or not the information protection flag in the electronic document 1207 in the DB1211 is set to “1”. If it is set to “1”, the DMA1206 deletes the electronic document 1207 from the electronic document DB device 1211 and registers the electronic document ID, deletion date and person performing the deletion in the deletion history management table 1201. Furthermore, even when the information protection flag is “0”, deletion from the BDB as shown below is carried out.

Next, the DMA1206 retrieves the BDB in the connectable DB device used for electronic document backup and when it is readable/rewritable, the electronic document with the designated electronic document ID is deleted from the BDB. In order to improve BDB retrieval performance at this time, the creation date when the document to be deleted was created is recorded in the deletion history management table and the BDB backed up in the DB device before its creation date can also be set to be removed from the retrieval.

More specifically, the DMA1206 in FIG. 12 refers to the DB device 1208 used for electronic document backup and the CD1215 inserted in the portable storage medium read/storage device 1210. By means of this referring, the DMA1206 retrieves the electronic document that is in agreement with the electronic document ID of the electronic document 1207. In FIG. 12 the electronic document 1214 (the electronic document having the same ID as the electronic document ID of the electronic document 1207), which is the backup data of the electronic document 1207, is contained in the BDB1213. Consequently, the DMA1206 retrieves this electronic document 1214 using the ID from the BDB1213 and deletes it.

In this manner, in this embodiment it is possible in accordance with the command to remove the BDB data to automatically delete the electronic document that one does not wish to be referred to again also from the DB device used for electronic document backup in addition to the electronic document DB device.

Furthermore, even when the electronic document that is in agreement with the electronic document ID of the electronic document 1207 is present in the CD1215, as explained above if the electronic document ID of the electronic document 1207 is registered in the deletion history management table 1201, it is possible to prohibit restoration in a manner similar to that of the first embodiment. Additionally, in this embodiment when the information protection flag is set to “0”, the DMA1206 displays an error message on the display part of the PC1202 and the processing pertaining to deletion (delete BDB data also) may be interrupted. Also, after setup of the information protection flag is verified, the DMA1206 may interrupt the processing, display a window on the display part from which the information protection setup can be selected and have the operator carry out information protection setup. When the information protection setup is done by the operator at this time, the DMA1206 may cancel the interruption, delete the electronic document 1207 from the electronic document DB device 1205 and register the electronic document ID, the date of deletion and person performing the deletion in the deletion history management table 1201.

In this embodiment the deletion history management table 1201 may also be stored in the same DB device as any DB device that is different from the DB device that stores electronic documents. Through control by means of the deletion history management table DB device 1203 which is a DB device different from the DB device storing the electronic document as described above, it is possible to restore the deletion history management table 1201 when the DB or DB device is damaged. To prepare for such DB or DB device damage, it is preferable to back up many versions more frequently than the DB so that the latest possible data can be restored. This deletion history management table 1201 can be encoded and it is possible to prevent the electronic document from being removed through a malicious operation.

The DB1211 storing electronic documents separate from this can also be controlled by means of the DB device and with the objective of long term storage of a plurality of DB versions with PC or DB damage, PC system replacements and with specific dates, it is possible for them to be made as a BDB in the DB device. Additionally, the BDB can also be saved by using the portable storage medium read/storage device 1210 in, for example, the CD1215.

In this embodiment, when the electronic document to be deleted from the DB in the electronic document DB device is pulled up, it is possible for the DMA to function as a deletion means that deletes the electronic document from the DB in the electronic document DB device.

Furthermore, when the electronic document to be deleted from the DB in the electronic document DB device is pulled up, the DMA also deletes it from the electronic document backup DB device in addition to the electronic document DB device. That is, it is also possible for the DMA to function as a second deletion means deleting an electronic document corresponding to the electronic document pulled up from the BDB in the electronic document backup DB device from the electronic document backup DB device.

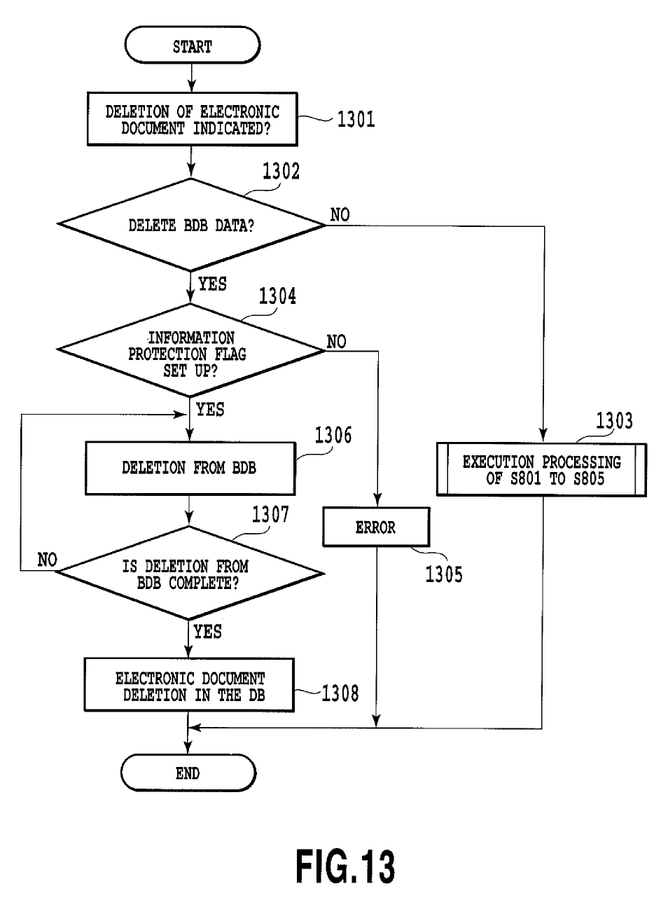

FIG. 13 is a diagram showing the flow chart that explains the deletion processing of the electronic document from the BDB by the operator in FIG. 12.

In S1301, when there is a deletion command from the operator for an electronic document, the DMA1206 receives the command for the electronic document to be deleted from the DB1211. In S1302, the DMA1206 determines whether or not the deletion command received in S1301 is the command relating to ‘delete (delete BDB data also)’. When it is not the command relating to ‘delete (delete BDB data also)’, the DMA1206 proceeds to S1303 and because the deletion command is ‘delete’ or ‘delete (prohibit restoration)’, steps S801 to S805 explained in FIG. 8 are carried out.

When the command is ‘delete (delete BDB data also)’, the DMA1206 proceeds to S1304, refers to the management table of the DB1211 and verifies that the information protection flag is set in the pulled up electronic document (S1304). If it is not set, the DMA1206 proceeds to S1305 and displays an error message on the display part of the PC1202 completing this processing.

If it is set, the DMA1206 proceeds to S1306, retrieves the electronic document having the same ID as the electronic document to be deleted from the DB device 1208 or 1209 used for electronic document backup and deletes it from the DB device used for the applicable electronic document backup (S1306). The DMA1206 determines whether or not the deletion of the electronic document is completed (S1307) and when not completed, carries out S1306 until it is. In S1308 the DMA1206 carries out deletion of the electronic document in the DB1211 in the electronic document DB device 1205 and the processing is completed.

### Third Embodiment

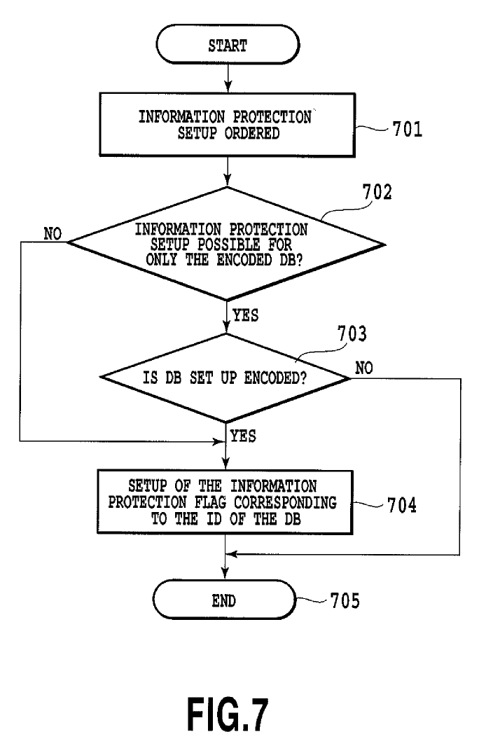

FIG. 7 is a diagram showing, in the setup of the information protection flag by the operator in FIG. 3, the flow chart explaining the processing in which the ‘information protection setup’ is only possible when the DB is encoded.

When the operator right clicks with the mouse and the ‘information protection setup’ of the pulldown menu is selected, the DMA300 receives the command relating to the information protection setup (S701). Next, the DMA300 determines whether or not the information protection setup for only the encoded DB in the DB device 308 is possible (S702) and if there is no setup, DMA300 proceeds to S704. If there is setup, the DMA300 proceeds to S703. In S703, the DMA300 determines whether or not the DB is set up encoded and if so, proceeds to S704. In S704, the information protection flag corresponding to the electronic document ID of the management table in the DB is set from “0” to “1” and processing is completed. In S703, if there is no setup, the processing is completed without change.

### The Fourth Embodiment

In embodiments 1 to 3, the ID relating to the electronic document that is set up to prohibit restoration is registered in the deletion history management table. For this case, as described above, because only the electronic document ID of the special electronic document is registered in the deletion history management table, it is possible to keep the amount of data in the deletion history management table to a minimum which is a much more preferable state. However, with this invention, it may be determined whether or not to prohibit restoration depending on whether the ID managed by the deletion history management table and the electronic document ID in the backup DB targeted for restoration are in agreement.

Therefore, not only may the electronic document ID for which restoration prohibition has been set up be registered but also can an electronic document ID for which restoration prohibition has not been set up, that is, an ID with allowable restoration setup (e.g. an ID when the information protection flag is set to “0”), may also be registered. That is, an ID relating to an electronic document with allowable restoration setup may be registered in the deletion history management table. For this case, when the ID of the electronic document receiving a restore command is in agreement with the ID in the deletion history management table, restoration is carried out and when they are not in agreement, restoration may be prohibited. Consequently, in this case also, by using an electronic document ID contained in the deletion history management table as identification information, restoration is prohibited. Further, for this case also, the deletion history management table is the table having at the very least the electronic document ID of the deleted electronic document which is the target of the allowable restoration.

### Other Embodiments

A program operating the structure of the above described embodiments in order to achieve the functions of the above described embodiments is recorded in the storage medium, the program stored in the storage medium is read as code and the processing method executed in the computer also is contained in the category of the above described embodiments. Furthermore, the computer program for the storage medium in which the above described program is stored is, of course, also included in the above described embodiments.

It is possible to use a floppy (registered trademark) disk, hard disk, optical disk, magneto-optical disk, CD-ROM, magnetic tape, non-volatile memory card or ROM as the storage medium.

This invention is not limited to devices carrying out the processing with single programs recorded in the above described storage media and devices operating on an OS and running the above described embodiments in conjunction with other software and expanded board functions are contained in the category of the above described embodiments.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-100272, filed Apr. 6, 2007, which is hereby incorporated by reference herein in its entirety.

What is claimed is:

1. A document management system comprising:
a storage device that stores a electronic document group;
a backup storage device that obtains the electronic document group stored in the storage device to store; and
a deletion means for deleting an electronic document from the electronic document group in the storage device when the electronic document to be deleted of the electronic document group stored in the storage device is indicated;
wherein the document management system comprises a control means that deletes the indicated electronic document from the storage device, and controls so that an electronic document corresponding to the indicated electronic document of the electronic document group stored in the backup storage device is not transferred to the storage device, when the electronic document to be deleted from the electronic document group stored in the storage device is indicated.

2. The document management system according to claim 1, wherein the control means has a registering means that registers an identification information of the indicated electronic document to be deleted in the electronic document group; and does not carry out restoration from the backup storage device to the storage device, when the identification information is registered by the registering means.

3. The document management system according to claim 1, wherein the control means, when the electronic document to be deleted of the electronic document group stored in the storage device is indicated, retrieves the electronic document corresponding to the indicated electronic document of the electronic document group stored in the backup storage device to delete.

4. A control method of a document management system comprising:
a storage device that stores a electronic document group;
a backup storage device that obtains the electronic document group stored in the storage device to store; and
a deletion means for deleting an electronic document from the electronic document group in the storage device when the electronic document to be deleted of the electronic document group stored in the storage device is indicated;
wherein the control method has a control step that deletes the indicated electronic document from the storage device, and controls so that an electronic document corresponding to the indicated electronic document of the electronic document group stored in the backup storage device is not transferred to the storage device, when the electronic document to be deleted from the electronic document group stored in the storage device is indicated.

5. The control method of the document management system according to claim 4, wherein the control step has a registering step that registers an identification information of the electronic document indicated to be deleted in the electronic document group, and does not carry out restoration from the backup storage device to the storage device, when the identification information is registered in the registering step.

6. The control method of the document management system according to claim 4, wherein the control step, when the electronic document to be deleted of the electronic document group stored in the storage device is indicated, retrieves the electronic document corresponding to the indicated electronic document of the electronic document group stored in the backup storage device to delete.

7. A computer readable storage medium storing the computer program that allow the computer to function as the means described in claim 1.
